(19) United States
(12) Patent Application Publication
(10) Pub. No.: US 2014/0274311 A1
(43) Pub. Date: Sep. 18, 2014

(54) SYSTEM AND METHOD FOR MEMBERSHIP-BASED SPORTS BOOK AND BETTING EXCHANGE

(71) Applicant: Brian Aronowitz, Briarcliff Manor, NY (US)

(72) Inventor: Brian Aronowitz, Briarcliff Manor, NY (US)

(21) Appl. No.: 13/836,489

(22) Filed: Mar. 15, 2013

(51) Int. Cl. G07F 17/32

(52) U.S. Cl. CPC G07F 17/3288; G07F 17/3244
USPC 463/25

(57) ABSTRACT

A method and system for providing an online membership gaming service where sports book and exchange players are members of a social media community and platform where they may bet on the outcomes of sporting events without the risk of losing their own money. The method comprises receiving entries into one or more sports book and exchange contests from a plurality of subscription members. A betting fund is distributed to each of the subscription members and the amount distributed is based on a predetermined amount associated with the one or more sports book and exchange contests and/or membership level. Bets are received from the plurality of subscription members. One or more winners of the one or more sports book and exchange contests are determined based on a total amount of the betting fund of each of the plurality of subscription members based on one or more outcomes of the bets.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The invention described herein generally relates to a subscription-based online sports book and sports betting exchange system.

### BACKGROUND OF THE INVENTION

In the United States, a sports book is a location where gamblers can wager on various sports events, including: football, basketball, baseball, hockey, golf, soccer, horse racing, boxing, mixed martial arts and various exotic bets. The term “book” historically comes from the actual notebook that those receiving the bets and making the lines would use to keep track of bets. A sports book will often feature all the active games available to bet in the market, along with the odds and associated betting lines displayed prominently. The addition of a betting line or point spread is referred to as sports handicapping, or the practice of assigning an advantage to one side of a bet through scoring compensation in order to equalize the chances of winning. In this manner, the sports book tries to ensure itself a profit by balancing their book: getting an even number of bets for each outcome or getting the amounts wagered on each outcome to reflect the odds.

As of 2013, betting on sports is illegal in all but a few US states, but has proliferated in the online marketplace, offshore, in Europe and overseas. The most notable, legal sports books in the US are located in Las Vegas. As a result, and with the advent of the Internet, sports betting is running rampant online and is largely unregulated, regulated in certain Caribbean islands or on Native American reservations. Many US sports bettors have flocked to online sports books that don't have access to states where sports betting is legal. These players enjoy the action of sports betting but are confused as to the legality of online sports betting, with the federal government, states, regulators, media and pundits all interpreting laws differently. Nonetheless, sports betting continues online for US players. In addition, several US states have recently adopted laws making betting online legal. What is clear is that the law surrounding sports betting online is in its infancy.

In Europe, the betting activities of sports book bettors have traditionally been restricted by bookmakers in terms of establishing betting lines (e.g., if they were to start winning too much money). As a result, sports bettors have turned to betting exchanges, sometimes referred to as peer-to-peer betting exchanges, since they can place bets of any size, the only restriction being that one or more opposing bettors need to be willing to match their bets to consider them action. A traditional betting exchange is an entity which provides a trading platform or system for sports bettors to buy and sell contracts. These contracts are often binary options, where the payoff is either some fixed amount of money or nothing at all, dependent on the outcome of a future sports event. Traditional betting exchanges make money by charging a commission, often a percentage of net winnings for each sports bettor on each event, or market. The odds available on a betting exchange are usually better than those offered by sports books even factoring the commission charged, because there are smaller overrounds (what gives the sports book its profit). As such, betting exchanges thrive on the liquidity of the market and sports bettors are content, often with better odds that at their favorite sports book.

As with sports books, the question of legality of betting exchanges remain largely unregulated and unclear. The traditional sports book and exchange models do not allow for players to become members of a social media community and platform to bet on the outcomes of sporting events without the risk of losing their own money. Moreover, traditional sports book and exchanges do not operate by a membership model, including benefits like content, discounts on goods and services and the opportunity to play in contests for prizes. Present in the market today are computerized betting systems for subscription-based pari-mutuel/lottery wagering and subscription-based poker wagering. As such, a substantial void exists for the most in-demand portion of modern gaming: a subscription-based sports book and sports betting exchange system.

### SUMMARY OF THE INVENTION

The present invention provides a method and system for an online membership sports betting and gaming service. The method comprises receiving a plurality of subscription member entries into one or more virtual sports book and exchange contests. A virtual betting fund is distributed to each of the plurality of subscription members associated with the plurality of subscription member entries and the amount of the betting fund distributed is based on a predetermined amount associated with the one or more sports book and exchange contests. A plurality of betting fund bets are received from the plurality of subscription members where the plurality of betting fund bets are associated with the one or more contests. The betting fund of each of the plurality of subscription members are updated based on one or more outcomes of the sports events and associated fund bets, and one or more winners of the one or more virtual sports book and exchange contests are determined based on a total amount of the betting fund of each of the plurality of subscription members.

A virtual sports book and exchange associated with event-based betting may be established for running one or more virtual sports book and exchange contests. The one or more virtual sports book and exchange contests include sports betting such as on football, basketball, hockey, baseball, soccer, auto, horse and dog racing (both of which are non pari-mutuel), golf, mixed martial arts (MMA), boxing, tennis, and other types of betting events. The plurality of subscription members may be associated with membership levels. Membership levels may include non-paying membership level and a plurality of fee-paying membership levels. According to some embodiments, the plurality of fee-paying membership levels are based on membership benefits, and the fees from the plurality of fee-paying membership levels are not used to bet with. Determining one or more winners may include determining one or more subscription members with a highest total betting fund amount. The determined one or more winners may also be awarded with one or more prizes. In certain embodiments, the value of the one or more prizes is not associated with the plurality of betting fund bets.

Distributing a betting fund to each of the plurality of subscription members may further include distributing a fictitious bankroll to each of the plurality of subscription members. In certain embodiments, distributing a betting fund to each of the plurality of subscription members may include distributing betting funds based on membership levels of the plurality of subscription members. The one or more winners are determined upon the end of a predetermined duration of the one or more virtual sports book and exchange contests. The predetermined duration of the one or more virtual sports book and exchange contests can be of a per event, daily, weekly, monthly, or annual basis.

The system comprises a processor and a memory having executable instructions stored thereon that when executed by the processor cause the processor to receive a plurality of subscription member entries into one or more virtual sports book and exchange contests. The processor is further operable to calculate odds, debit, credit and distribute a betting fund to each of the plurality of subscription members associated with the plurality of subscription member entries where the amount of the betting fund distributed is based on a predetermined amount associated with the one or more virtual sports book and exchange contests, and receive a plurality of virtual betting fund bets from the plurality of subscription members. The plurality of betting fund bets are associated with the one or more contests. In addition, the processor is further operable to update the betting fund of each of the plurality of subscription members based on one or more outcomes of the plurality of betting fund bets, and determine one or more winners of the one or more virtual sports book and exchange contests based on a total amount of the betting fund of each of the plurality of subscription members.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a computing system according to an embodiment of the present invention.

FIG. 2 illustrates a flowchart of a method for providing a sports book according to an embodiment of the present invention.

FIG. 3 illustrates a flowchart of a method for providing a betting exchange according to an embodiment of the present invention.

FIG. 4 illustrates a flowchart of a method for facilitating a contest according to an embodiment of the present invention.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the present invention. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

FIG. 1 presents a computing system according to an embodiment of the present invention. System 100 includes client device 102, 104, 106, network 128, and game server 108. The game server 108 is operable to provide online sports book and betting exchange services and gaming environment to users of client devices 102, 104, and 106 over network 128. Game server 108 comprises gaming platform 110, subscriber database 116, social media module 118, betting processor 120, real-time information aggregator 122, bankroll manager 124, contest and promotion database 126, and content module 128. In addition, one or more features, functionality, and services of game server 108 may be provided as a cloud service. Servers may vary widely in configuration or capabilities, but generally a server such as gamer server 108 may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like. Although illustrated as a single entity, game server 108 may be comprised of either one or more server devices.

Clients 102, 104, and 106 may comprise general purpose computing devices (e.g., personal computers, television set top boxes, mobile devices, terminals, laptops, personal digital assistants (PDA), cell phones, tablet computers, e-book readers, or any computing device having a central processing unit and memory unit capable of connecting to a network). A client device may include or may execute a variety of operating systems, including a personal computer operating system, such as a Windows, Mac OS or Linux, or a mobile operating system, such as iOS, Android, or Windows Mobile, or the like. A client device may include or may execute a variety of possible applications, such as a client software application enabling communication with other devices, such as communicating one or more messages, such as via email, short message service (SMS), or multimedia message service (MMS), including via a network, such as a social network, including, for example, Facebook, LinkedIn, Twitter, Flickr, or Google+, to provide only a few possible examples. A client device may also include or execute an application to communicate content, such as, for example, textual content, multimedia content, or the like. A client device may also include or execute an application to perform a variety of possible tasks, such as browsing, searching, playing various forms of content (e.g., from content module 128 or via social media module 118), including locally stored or streamed video, or games. The foregoing is provided to illustrate that claimed subject matter is intended to include a wide range of possible features or capabilities.

Network 104 may be any suitable type of network allowing transport of data communications across thereof. In one embodiment, the network may be the Internet, following known Internet protocols for data communication, or any other communication network, e.g., any local area network (LAN), wide area network (WAN) connection, wire-line type connections, wireless type connections, or any combination thereof. A network may couple devices so that communications may be exchanged, such as between a server and a client device or other types of devices, including between wireless devices coupled via a wireless network, for example.

Users may access a gaming service, platform and environment provided by game server 108, by for example, navigating to a website via client devices 102, 104, and 106. According to one embodiment, game server 108 provides an online membership-based sports book and betting exchange, with the function, service, features, and excitement of an actual sports book and betting exchange, without the losses sustained by players (members) to the “house.” The membership-based sports book and betting exchange may offer game play that are similar to traditional gambling sites and members are subscribers to the sports book and betting exchange game play, but are not required to wager actual money. Subscribing members may receive benefits such as content from content module 128, a social community of sports enthusiasts, discounts and services and the opportunity to play in contests for prizes as part of sports book and betting exchange gaming. Content module 128 and/or social media module 118 may provide an interface between various content servers and game server 108. Upon visiting the website, users may be prompted to login to their account or become new members. The website may also include promotional content, also from content module 128, which may include demos, images, digital assets, content, social media, sample content, pictures, video, tutorials, testimonials, special offers and promotions, etc., to encourage users to subscribe or join.

Users who desire to sign up and become members may be guided through a sequence of steps to input personal information, including registering their “fan favorites” with the web site, such as of their favorite teams, players, sports, likes and dislikes. A secure session may be established for premium membership registration to input credit card and billing information. User registration and billing information may be stored securely in subscriber database 116. For example, the information stored in subscriber database 116 may be encrypted according to well-known industry standards. Users may be offered either a basic or premium membership. A basic membership to the gaming service can be free where no purchase is necessary. However, the free play variation of sports book and betting exchange games may or may not contain all the content, benefits, cash and/or prize(s) that a premium member may enjoy.

A basic membership may entitle members to entry-level features such as minimal access to sports book and betting exchange, content from content module 128, minimal/no access to other members through social media module 118, contests, and minimal bankroll. The basic membership may also allow members to participate in popular casino games, horse and dog racing (pari-mutuel) bets, and video game features not associated with gaming. According to one embodiment, a free basic membership may feature a free platform and social community that enables the various types of play described, with an advertising revenue model. For example, advertising banners, videos, and other forms of advertisements may be presented to a basic member or more often than what a premium member would experience. Members may securely upgrade their membership at any time to a premium membership, for a fee (e.g., monthly or annual subscription fees).

Premium members receive additional membership benefits, which may vary in subscription time and by premium membership level, including, exclusive content from content module 128, access to other members via social media module 118, digital assets, discounts and services, coupons, special offers, VIP experiences, and various other benefits not available to basic members and visitors to the site. Premium members may also not be shown ads throughout the user experience. It is noted that the fee paid by premium members may not used for wagering. Instead, premium members pay a fee to subscribe to the additional membership benefits that are not available to basic members. Premium members may increase their bankroll commensurate with a desired membership-level (e.g., beginner, intermediate, or advanced), which can also increase the skill levels of the members that they compete against. Premium membership may also increase a contest period, grant access to exclusive contests, and/or access to other premium members, increase benefits, and elevate the level of content and/or digital assets. Premium members may also join via their premium membership subscription, sports services subscriptions for the duration of a sports season, such as the duration of football, basketball seasons, for a specific contents, or for specially designated periods of time (a subscription period). Contests, cash and/or prize(s) may vary by the premium membership subscription duration and premium membership level. Members with higher membership levels may enjoy better benefits than those of lower tiered membership levels. Accordingly, each membership-level may be priced at a fee based on the amount of benefits a member can receive.

Gaming platform 110 is operable to allow members to place bets on outcomes of sporting events via sport book 112 and exchange 114. Sports book 112 may offer the feel and atmosphere of a traditional, offline sports book and provides all contests presently in play to members. Members are able to join one or more contests and are afforded the ability to play by choosing the qualifying sports event, type of bet, and amount of bet through completion and confirmation of their bet. A given sports book contest may include a competition among members who have entered the contest to compete by betting on qualifying sports events to obtain a highest bankroll amount for a specific duration (e.g., per event, daily, weekly, monthly, and annual contests). Real-time information aggregator 122 may retrieve information associated with the bets received by betting processor 120 such as scores, statistics, a winner/loser, etc. that determines the outcome of the bets. Members have the ability to see a complete reconciliation of pending bets, bets won and bets lost for that contest.

The sports book 112 and exchange 114 offers betting of fictitious bankrolls. Members may place bets on sports book 112 and exchange 114 using fictitious betting funds (e.g., betting chips, coins, or points) against a fictitious “house” (betting processor 120) or against each other (via exchange 114) to compete for the largest bankroll at the end of a contest in order to win and be awarded with cash and/or prize(s). The cash or prizes may be determined upon creation of the contest and their value or worth does not depend on the amount of fictitious betting funds betted. Bankroll manager 124 may manage fictitious bankroll accounts for each member and credit or debit fictitious betting funds between bankroll accounts upon betting outcomes. According to one embodiment, members may be given an initial bankroll amount for each contest they enter. In another embodiment, members may be given a bankroll for a full sports season. Regardless, once a member exhausts his/her bankroll in a given contest, participation ends for that member and they may wait for the beginning of a next contest where they may be eligible to enter. Members do not wager against the house and do not risk losing real money.

Play in sports book 112 includes all forms of sports betting on qualifying sports, non-athletic human contests, or other types of events that can be betted on. Examples of qualifying sports events include football, basketball, hockey, baseball, soccer, auto, horse and dog racing (both of which are non pari-mutuel), golf, mixed martial arts (MMA), boxing, tennis, exotics, live betting and other sports events, foreign and domestic. Other events that can be betted on may include political elections, television reality show outcomes, weather forecasts, etc. The rules of which are in play offered by the sports book 112 may include: straight bets, money line bets, parlays, point-spread wagers, teasers, parlays, if bets, futures and proposition bets, live betting and other forms of popular wagers present in the market today and those yet to be identified. Play can vary by a given member's skill set, conservative or aggressive method of play, and external influencers. Betting processor 120 may perform book maker or book maker-like functions including receive bets from a plurality of members on sporting and other events at certain agreed upon odds. The betting processor 120 may not profit from the bets themselves, and rather acts as a simulated market maker.

In addition, the range of members in a contest may vary from house-sponsored ones (generated by betting processor 120) to like-subscribed members organizing themselves into groups, such as those members of an external fantasy league, or challenging like-subscribed members trolling a virtual lobby, similar to the experience of trolling an actual offline sports book looking for action, to members soliciting new like-subscribed members and challenging amongst themselves via social media module 118, content module 128, or some other form of communication on the internet, such as through other gaming systems.

According to most embodiments, a distinguishing feature offered by sports book 112 over traditional sports books such as those found in Las Vegas, is that sports book 112 may feature a guaranteed to members to never lose money betting on sports book 112. Members are able to receive the thrill of betting action and do not suffer defeat in the form of losing money to the house if they lose their bankroll. Sports book 112 does not require buy-ins or deposits. Sports book 112 accepts bets with virtual bankrolls, maintains spreads and odds (fractional and decimal), but does not keep a “vigorish” (percent the house retains), and does not have the revenue streams as traditional sports books do to ensure a profit regardless of the outcome of an event. Rather, sports book 112 is part of a platform, website, social media and community offered by game server 108 that enables members that enjoy sports betting to play without risking their money.

An exemplary contest may include participation of 5,000 basic members, each starting with a virtual bankroll of $2,500. The contest duration may be the 16-week National Football League (NFL) regular football season with all bets offered by sports book 112 as action. The top 10 members with the largest virtual bankroll at the end of the contest may receive an autographed helmet of their favorite football player. This contest may also have weekly consolation prizes for a contestant member with the largest winning bankroll of bets in a given NFL week. The consolation prize could be, for example, a pair of tickets, upper-level, end zone or better, to see their favorite NFL team play the following week.

Another exemplary contest may include participation of 500 intermediate-level premium members with a starting virtual bankroll of $10,000. Here again, the contest duration may be the 16-week NFL regular football season with all bets offered by sports book 112 as action. Being intermediate-level premium members, the top 10 members with the largest virtual bankroll at the end of the contest may enjoy a better prize than that of a contest for basic members such as an all-inclusive trip to the NFL Super Bowl. This contest may also have weekly consolation prizes for a member with the largest winning bankroll of bets in that NFL week. The consolation prize may be a pair of tickets at the 50 yard-line to see their favorite NFL team playing the following week, including transportation to and from the event, as well as VIP access to pre and post game parties. In yet another exemplary contest, 100 advanced-level premium members may participate with a starting virtual bankroll of $100,000. The contest duration may also be the 16-week NFL regular football season with all bets offered by sports book 112 as action. As a benefit of being an advanced-level member, the top 10 members with the largest virtual bankroll at the end of the contest will receive $10,000 and weekly consolation prizes for the member with the largest winning bankroll of bets in a given NFL week may be $1,500.

During a contest, premium members may also utilize resources and content provided by content module 128, as part of their premium subscription, to hone their skills against other players. Content module 128 may provide sports statistics, sports news, digital assets, information and picks/opinions (such as from handicapping experts), chat rooms/advice from other members, and social media (e.g., social media module 118 may retrieve “tweets” from Twitter and “likes” from Facebook). A skilled premium member can use the content to leverage themselves a competitive advantage over other members, making favorable betting decisions with their bankroll. In most embodiments, members do not use actual money directly to play in sports book, nor do they make cash deposits, as prevalent in online/offshore sports books. Members may receive fictitious, virtual bankrolls from bankroll manager 124 and play in sports book 112, betting the bankroll on qualifying sports events, competing in a game of skill, among themselves (not the house), for the largest bankroll during the contest period. Winning bets are “paid” to the members bankroll when the qualifying sports event finishes (by either betting processor 120 or bankroll manager 124, or a combination of both), or if not finished, when played long enough to become official; otherwise all bets are returned. The member with the largest bankroll at the end of the contest wins the designated prize(s) for that contest. In the discussed embodiment, a member's bankroll does not hold actual cash value, regardless of its size, and will not be paid out as a cash value.

Participation in exchange 114 varies from sports book 112 such that instead of players playing against the “house” facilitated by betting processor 120 (albeit, the house is fictitious in the sports book 112) they are making bets against each other. The exchange 114 may be viewed as a peer-to-peer betting system. Exchange 114 offers the opportunity for members to both back and lay against each other. Members participating in exchange 114 may also compete in contests to accumulate a highest bankroll amount by betting on qualifying sports events for a specific duration. Members participating in exchange 114 buy and sell wagering contracts among themselves using virtual bankrolls.

Every bet transacted on exchange 114 requires a backer matched to a layer such that a bet can be paired up with a matching counter-bet. If a bet goes unmatched with a member unwilling to take the other side, it is considered a “no-match” and the bet cannot be taken. A further feature the exchange 114 may offer is the ability for members to make bets while the event is live and in progress, often referred to as “in-running” or “in-play” betting. According to most embodiments, regardless of the variation, contest size, duration, starting bankroll, eligible play/bets and/or prize, a distinction between exchange 114 and traditional exchanges, is that members are offered a guarantee to never lose money betting on exchange 114. Members can receive the thrill of betting action and yet, if they lose their bankroll, they do not suffer defeat in the form of losing money to other players and/or paying commissions/overruns to the house. Buy-ins and deposits are not required to play on exchange 114. According to some embodiments, exchange play may provide members with better odds than with sports book, although exchange 114 may be regulated if necessary and/or display the odds of winning to ensure fairness amongst members. Further to this point, sports book 112 and exchange 114 may be monitored and/or audited by a third party to ensure fairness amongst its members.

For example, an exemplary exchange play may include a Member A who thinks that the N.Y. Giants will win by 7 points, he is “backing” the team. Member A posts his interest on exchange 114, seeking another member looking for action on the opposite side of a N.Y. Giants win by 7 points, betting 5 virtual dollars. A Member B may come along and think the N.Y. Giants will lose, so Member B selects Member A's action and “lays” that the N.Y. Giants will not win by 7 or more points, betting 5 virtual dollars on the opposite side on exchange 114. The two are now engaged in action on a specific event and outcome. In this example, if the N.Y. Giants win by 7 or more, Member A wins and keeps Member B's bet. If the N.Y. Giants win by 6 or less or lose, Member B wins and keeps Member A's bet. The bet is credited to the winning members' fictitious, virtual bankroll by either betting processor 120 or bankroll manager 124, or a combination of both.

Users may register their social networking accounts, such as on Facebook or Twitter, with game server 108. In another embodiment, members may register and sign-in to game server 108 on the website using their social networking accounts. Social media module 118 may associate and link a user's social networking account with a membership account to game server 108. Furthermore, users who sign up with game server 108 may form a social media community or a social network with other members to interact, communicate and compete against each other. Each member in the social network may have a user profile viewable by other members including their names, performance, accomplishments, and contact information, etc. Social media module 118 may allow users to post their user profiles to one or more of their social networking accounts. Members may also be encouraged to network with other members, brag, “talk trash,” and share content via the social media community or their social networking accounts. They will also create content to be used and stored in content module 128.

The term “social network” refers generally to a network of individuals coupled via a communications network or via a variety of sub-networks. Potentially, additional relationships may subsequently be formed as a result of social interaction via the communications network or sub-networks. A social network may be employed, for example, to identify additional connections for a variety of activities, including, but not limited to, dating, job networking, receiving or providing service referrals, content sharing, creating new associations, maintaining existing associations, identifying potential activity partners, performing or supporting commercial transactions, or the like. A social network may include individuals with similar interests, experiences, opinions, education levels or backgrounds. Subgroups may exist or be created according to user profiles of individuals, for example, in which a subgroup member may belong to multiple subgroups. An individual may also have multiple “one-to-few” associations within a social network, such as for family, college classmates, or co-workers.

An individual's social network may refer to a set of direct personal relationships or a set of indirect personal relationships. A direct personal relationship refers to a relationship for an individual in which communications may be individual to individual, such as with family members, friends, colleagues, co-workers, or the like. An indirect personal relationship refers to a relationship that may be available to an individual with another individual although no form of individual to individual communication may have taken place, such as a friend of a friend, or the like. Different privileges or permissions may be associated with relationships in a social network. A social network also may generate relationships or connections with entities other than a person, such as companies, brands, or so called “virtual persons.” An individual's social network may be represented in a variety of forms, such as visually, electronically or functionally. For example, a “social graph” or “socio-gram” may represent an entity in a social network as a node and a relationship as an edge or a link.

FIG. 2 presents a method for providing a sports book according to an embodiment of the present invention.

Users may visit a home page web site via their client devices to access an online sports book platform. A user is prompted for user identification to participate in the sports book and betting exchange, step 202. Members may be prompted to login to their account or first time users may sign up for their own account. An indication is received from a given user whether he/she is a member, step 204. If the user is a member, the indication received from the user may include login information such as a login ID and password.

The login information provided by a member is used to retrieve member information, step 206. The retrieved member information may include the member's name, membership level, entered contests, bankroll, an avatar, etc. However, if the user indicates that they are not an existing member, the user is prompted for new member information and is enrolled, step 208. The user may be asked to fill out a registration form where information provided on the registration form is used to enroll the user as a member and create a new user profile.

In a next step 210, after step 206 or 208, sports book gaming and wagering options are provided to the user. The user may be logged in using either the retrieved member information for a current member or the received member information from a new member and is presented with navigation functions to select between sports book contests, a list of eligible sports from which to bet, member services, such as my membership, contests, bankroll, stats, picks, tools, rewards, customer service, customer service help, FAQs, chat, messages and various social media features. Sports book betting plays may be available to members based on, for example, their membership level, and entered contests. For example, a sports book betting screen may comprise a tote board presentation like that of a typical offline sports book, including content offering for the level of membership, a sortable list of all eligible contests in action, solicitations for the member to join new eligible contests, pending bets and their status, status of the member in his/her various contests, and social media prompts.

Indication of contest participation, join and wager are received, step 212. The user may select a given contest to either join a contest or make a wager in the contest. For example, a user experience may be similar to how contests in online poker rooms are accessed. Specifically, the aspects of seeing available contests, member eligibility, stakes and or bet types, and the contests status. In any given sports book contest, members may be free to place any bets with their bankrolls and play as much as they desire. Contests may vary in duration, content, sponsors (if present), which members are eligible to participate, the number of members participating, qualifying sports events, eligible or non-eligible bets, and cash/prize(s) (“contests”). Contest duration can vary from one day to a year, a number of hours, or even for a single bet. Users may consult pre-determined contest rules for specific rules governing a contest.

A user that seeks to join a contest selects a contest of interest and is taken to a contest information screen. There, the user is offered all salient information about the contest including duration, number of members, prize, and eligible bets. If the user wishes to take part in the contest, they can register and play in the contest. The contest may provide one or more bets that the user can place with fictitious betting funds, such as credit, points, or coins from their available bankroll. Fictitious betting funds from placed bets may be “held” in a pool or holding fund associated with its contest. In another embodiment, bankrolls may be settled upon the conclusion and settlement of wagering outcomes. Bets may be accepted for a given contest up to a certain cut-off point (e.g., the start of a game, finite period of time, or contest).

In step 214, wagering outcomes are determined. Winning and losing bets may be determined upon the conclusion of a game, event, or betting play. Upon determining the wagering outcomes, the winnings are distributed, step 216. Funds held in the contest pool for the bet may be distributed to members of winning bets' accounts. At the end of a designated contest, the participating member(s) with the highest bankroll(s) may be awarded cash and/or prize(s) including, but not be limited to tickets and travel to their favorite sports events and concerts, memorabilia from their favorite sports teams or celebrities, “one-of-a-kind” VIP fan experiences, additional specialized content, an entry into an exclusive contest, and/or the granting of a premium membership.

FIG. 3 presents a method for providing a betting exchange according to an embodiment of the present invention.

Users may visit a home page web site via their client devices to access an online betting exchange platform. Steps 302, 304, 306, and 308 are substantially similar to steps 202, 204, 206, and 208, and discussion of such are omitted for brevity purposes only. After a user has provided either their user identification or has been enrolled as a new member via steps 302, 304, and 306 or 302, 304, and 308, respectively, exchange gaming and wagering options are provided in step 310. At this point, members may be given the option to ‘toggle’ between the exchange and sports book features of 310 and 210. The user may be logged in using either the retrieved member information for a current member or the received member information from a new member and is presented with navigation functions to select exchange contests, a list of eligible sports from which to bet, member services, such as my membership, contests, bankroll, stats, picks, tools, rewards, customer service, customer service help, FAQs, chat, messages and various social media features. Exchange bets may be available to users based on, for example, their membership level, and entered contests.

Indication of contest participation and post wager contracts are received, step 312. The exchange may offer contests for members to buy and sell contracts on qualifying sports events, horse and dog races, and special events, etc. These contracts may be binary options—a fixed bet or nothing at all, dependent on the outcome of the event. The user may select a given contest to either join a contest or make a bet in the contest. The contest may allow a user to place one or more bets (or buy and sell contracts) with their bankroll. In any given exchange contest, members may be free to place any bets with their bankrolls and play as much as they desire, provided that their bets are matched to an opposing, equal bet. Contests may vary in duration, content, sponsors (if present), which members are eligible to participate, the number of members participating, qualifying sports events, eligible or non-eligible bets, and cash/prize(s) (“contests”). Contest duration can vary from one day to a year, a number of hours, or even for a single bet.

Wager contracts are matched with opposing members, step 314. The exchange accepts all matched bets with virtual bankrolls and maintains the platform to buy and sell wagering contracts for each event. Bets may be accepted for a given contest up to a certain cut-off point (e.g., the start of a game) or members may be allowed to make bets while the event is live and in progress (“in-running” or “in-play” betting). Wagering outcomes are determined, step 316. Winning and losing bets may be determined upon the conclusion of a game, event, or betting play. Upon determining the wagering outcomes, bankrolls of the winning members are credited from the losing members' bankrolls to fulfill the wagering contracts, step 318.

FIG. 4 presents a flowchart of a method for facilitating a contest according to an embodiment of the present invention.

A contest may be generated for an online gaming platform, step 402. The contest may be generated in either sports book or betting exchange formats. A contest may be based on certain parameters such as a required membership level or player experience to participate, an initial bankroll to start every member contestant off with, a maximum and/or minimum number of participants, prize(s), one or more conditions to win prize(s), duration, a theme or sports genre, winning and losing conditions, and eligible bets. The prize(s) may be determined during the creation of the contest and their value or worth does not depend on the amount of fictitious betting funds betted. Once a contest is generated, members may view contest details, and eligible members able to participant in the contest may enter the contest.

Contest entries are received, step 402. The contest may accept member participation for a contest until, for example, either a maximum number of participants have been reached or upon a contest start date with a minimum number of participants. Upon the start of the contest, participating members are provided initial bankroll, step 406. The initial bankroll may be used to wager in bets associated with the contest. Initial bankrolls may either be the same for each participating member or based on a member's subscription level.

In a next step 408, a round of bets is received. The contest may be open to receive bets from participants of the contest (member contestants). The outcome of the received bets are determined, step 410. Winning and losing bets may be determined upon the conclusion of a game, event, or betting play. Based on the outcome of the bets, member contestants' bankrolls are updated, step 412. From the betting outcomes, bankrolls of the winning member contestants may be credited based on their bets. In exchange betting, the winning member contestants' bankrolls may be credited from the losing member contestants' bankrolls as stipulated by agreed upon wagering contracts.

In step 414, a determination is made as to whether the contest has ended. After a round of bets and concluded outcomes, the contest may be determined to have ended based on the contest duration, the winning and losing conditions, or a combination of both. If the contest is not over, next, in step 416, a determination is made as to whether each member contestant has a bankroll greater than $0 (i.e., they still have betting funds in their bankroll to bet with). Member contestants with bankrolls greater than $0 are allowed to continue betting and advance to a next round of bets, step 408. However, once a member contestant exhausts his/her bankroll, participation in the contest ends for that member contestant, step 422. Losing member contestants may await the beginning of and enter into another contest where they meet eligibility.

If the contest has ended, one or more contest winners are determined, step 418. A winning member contestant may be contacted the next business day by a member of a VIP team, to arrange for awarding the member contestant with their prize(s). One or more consolation prize winners are also determined, step 420. The consolation prizes may be given out to member contestants satisfying conditions for winning a consolation prize. Consolation prizes are mostly awarded at the conclusion of a contest. In some certain embodiments, consolation prizes may also be distributed at predefined periods within the duration of the contest. For example, the contest may give a small prize to a member contestant with the highest bankroll for the first week in a month-long contest. Consolation prizes may also be awarded to players who achieve certain milestones during a contest. In some instances, there may be no consolation prize(s) or winners. The game is ended for the remaining member contestants and they are declared as losing players, step 422.

FIGS. 1 through 4 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method for providing an online membership gaming service, the method comprising:
receiving a plurality of subscription member entries into one or more virtual sports book and exchange contests;
distributing a betting fund to each of the plurality of subscription members associated with the plurality of subscription member entries, the amount of the betting fund distributed is based on a predetermined amount associated with the one or more virtual sports book and exchange contests;
receiving a plurality of betting fund bets from the plurality of subscription members, the plurality of betting fund bets associated with the one or more contests;
updating the betting fund of each of the plurality of subscription members based on one or more outcomes of the plurality of betting fund bets; and
determining one or more winners of the one or more virtual sports book and exchange contests based on a total amount of the betting fund of each of the plurality of subscription members.

2. The method of claim 1, further comprising establishing a virtual sports book associated with event-based betting.

3. The method of claim 1, further comprising establishing an exchange for wagering contracts associated with event-based betting.

4. The method of claim 1, wherein each of the plurality of subscription members are associated with one of a plurality of membership levels.

5. The method of claim 4, further comprising awarding the one or more winners with one or more prizes, wherein a value of the one or more prizes is based on the membership levels of the one or more winners.

6. The method of claim 4, wherein the plurality of membership levels include a non-paying membership level and a plurality of fee-paying membership levels.

7. The method of claim 6, wherein the plurality of fee-paying membership levels are based on membership benefits.

8. The method of claim 6, wherein fees from the plurality of fee-paying membership levels are not used to bet with.

9. The method of claim 1, wherein determining one or more winners further includes determining one or more subscription members with a highest total betting fund amount.

10. The method of claim 1, wherein determining one or more winners further includes awarding the one or more winners with one or more prizes.

11. The method of claim 10, wherein a value of the one or more prizes is not associated with the plurality of betting fund bets.

12. The method of claim 1, wherein the one or more virtual sports book and exchange contests includes sports betting.

13. The method of claim 1, wherein distributing a betting fund to each of the plurality of subscription members further includes distributing a fictitious bankroll to each of the plurality of subscription members.

14. The method of claim 1, wherein distributing a betting fund to each of the plurality of subscription members further includes distributing betting funds based on membership levels of the plurality of subscription members.

15. The method of claim 1, wherein the one or more winners are determined upon the end of a predetermined duration of the one or more virtual sports book and exchange contests.

16. The method of claim 1, wherein the predetermined duration of the one or more virtual sports book and exchange contests is one of a daily, weekly, monthly, annual, or per event basis.

17. The method of claim 1, further comprising generating content for the plurality of subscription members, the content including at least one of sports statistics, sports news, digital assets, information, handicapper picks, and opinions from handicapping experts, chat rooms, advice from other subscription members, content created by members from interaction with the site and social media.

18. The method of claim 1, wherein the online membership gaming service includes a social media platform.

19. A system for providing an online membership gaming service, the system comprising:
a processor; and
a memory having executable instructions stored thereon that when executed by the processor cause the processor to:
receive a plurality of subscription member entries into one or more virtual sports book and exchange contests;
distribute a betting fund to each of the plurality of subscription members associated with the plurality of subscription member entries, the amount of the betting fund distributed is based on a predetermined amount associated with the one or more virtual sports book and exchange contests;
receive a plurality of betting fund bets from the plurality of subscription members, the plurality of betting fund bets associated with the one or more contests;
update the betting fund of each of the plurality of subscription members based on one or more outcomes of the plurality of betting fund bets; and
determine one or more winners of the one or more virtual sports book and exchange contests based on a total amount of the betting fund of each of the plurality of subscription members.

20. Non-transitory computer readable media comprising program code that when executed by a programmable processor causes execution of a method for providing an online membership gaming service, the computer readable media comprising:
computer program code for receiving a plurality of subscription member entries into one or more virtual sports book and exchange contests;
computer program code for distributing a betting fund to each of the plurality of subscription members associated with the plurality of subscription member entries, the amount of the betting fund distributed is based on a predetermined amount associated with the one or more virtual sports book and exchange contests;
computer program code for receiving a plurality of betting fund bets from the plurality of subscription members, the plurality of betting fund bets associated with the one or more contests;
computer program code for updating the betting fund of each of the plurality of subscription members based on one or more outcomes of the plurality of betting fund bets; and
computer program code for determining one or more winners of the one or more virtual sports book and exchange contests based on a total amount of the betting fund of each of the plurality of subscription members.
